(19) United States
(12) Patent Application Publication
(10) Pub. No.: US 2025/0186890 A1
(43) Pub. Date: Jun. 12, 2025

(54) VIRTUAL OBJECT CONTROL IN APPLICATION

(71) Applicant: Beijing Zitiao Network Technology Co., Ltd., Beijing (CN)

(72) Inventor: Yiming WEI, Beijing (CN)

(21) Appl. No.: 18/972,189

(22) Filed: Dec. 6, 2024

(30) Foreign Application Priority Data
Dec. 10, 2023 (CN) 202311688650.5

(51) Int. Cl. A63F 13/57; A63F 13/213

(52) U.S. Cl. CPC A63F 13/57; A63F 13/213

(57) ABSTRACT

A method, apparatus, device and medium for controlling a virtual object in an application are provided. In the method, in response to a determination that a first action sequence of a user of the application matches a first predetermined action sequence, a set of virtual objects is presented in a display area of the application with a first format. A target virtual object in the set of virtual objects is determined based on a user interaction of the user. In response to a determination that a second action sequence of the user matches a second predetermined action sequence, an operation corresponding to the target virtual object is performed. With example implementations of the disclosure, user interaction may be provided in a more flexible and efficient manner without interfering with the user's experience of using the application.

### CROSS REFERENCE TO RELATED APPLICATIONS

This application claims priority to Chinese Patent Application No. 202311688650.5, entitled “METHOD, APPARATUS, DEVICE AND MEDIUM FOR CONTROLLING VIRTUAL OBJECT IN APPLICATION” filed on Dec. 10, 2023, the entirety of which is incorporated herein by reference.

### FIELD

Example implementations of the present disclosure generally relate to application control, and in particular, to virtual object control in an application.

### BACKGROUND

In recent years, technologies such as virtual reality (VR) and augmented reality (AR) have been widely studied and applied. With a combination of hardware devices and a plurality of technical means, virtual contents are integrated with real scenes to provide users with unique sensory experiences. VR is a virtual world that simulates a three-dimensional space with computers, providing users with immersive experiences in visual, auditory, haptic, and other aspects. AR enables real environments and virtual objects to be overlaid in the same space in real time and exist at the same time. Currently, various applications have been developed based on VR and AR, which can detect actions of users of the applications, thereby controlling various virtual objects in the applications based on the detected actions. It would be desirable to provide a more flexible and convenient way to control various virtual objects.

### SUMMARY

In a first aspect of the present disclosure, a method of controlling a virtual object in an application is provided. The method includes: in response to a determination that a first action sequence of a user of the application matches a first predetermined action sequence, presenting, in a display area of the application, a set of virtual objects with a first format; determining, based on a user interaction of the user, a target virtual object in the set of virtual objects; and in response to a determination that a second action sequence of the user matches a second predetermined action sequence, performing an operation corresponding to the target virtual object.

In a second aspect of the present disclosure, an apparatus for controlling a virtual object in an application is provided. The apparatus includes: a first presenting module configured to, in response to a determination that a first action sequence of a user of the application matches a first predetermined action sequence, present, in a display area of the application, a set of virtual objects with a first format; a determining module configured to determine, based on a user interaction of the user, a target virtual object in the set of virtual objects; and a performing module configured to, in response to a determination that a second action sequence of the user matches a second predetermined action sequence, perform an operation corresponding to the target virtual object.

In a third aspect of the present disclosure, an electronic device is provided. The electronic device includes: at least one processing unit; and at least one memory coupled to the at least one processing unit and storing instructions to be executed by the at least one processing unit, the instructions, when executed by the at least one processing unit, causing the electronic device to perform the method according to the first aspect of the present disclosure.

In a fourth aspect of the present disclosure, there is provided a computer readable storage medium having stored thereon a computer program that, when executed by a processor, causes the processor to implement the method according to the first aspect of the present disclosure.

It should be understood that the content described in the SUMMARY section is neither intended to limit key features or important features of implementations of the present disclosure, nor is it intended to limit the scope of the present disclosure. Other features of the present disclosure will be readily understood from the following description.

### BRIEF DESCRIPTION OF THE DRAWINGS

The above and other features, advantages and aspects of implementations of the present disclosure will become more apparent hereinafter with reference to the following DETAILED DESCRIPTION taken in conjunction with the accompanying drawings. In the drawings, the same or similar reference numerals represent the same or similar elements, wherein:

FIG. 1 illustrates a block diagram of an application environment according to some example implementations of the present disclosure;

FIG. 2 illustrates a block diagram for controlling a virtual object in an application according to some implementations of the present disclosure;

FIG. 3 illustrates a block diagram for selecting a virtual object according to some implementations of the present disclosure;

FIG. 4 illustrates a block diagram of a structure of a wearable device according to some implementations of the present disclosure;

FIG. 5 illustrates a block diagram of performing an operation with a selected virtual object according to some implementations of the present disclosure;

FIG. 6A illustrates a block diagram of a predetermined action sequence for a selection operation according to some implementations of the present disclosure;

FIG. 6B illustrates a block diagram of a predetermined action sequence for a release operation according to some implementations of the present disclosure;

FIG. 7 illustrates a block diagram for specifying a predetermined action sequence according to some implementations of the present disclosure;

FIG. 8 illustrates a flowchart of a method of controlling a virtual object in an application according to some implementations of the present disclosure;

FIG. 9 illustrates a block diagram of an apparatus for controlling a virtual object in an application according to some implementations of the present disclosure; and

FIG. 10 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are illustrated in the drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are merely used for example, and are not intended to limit the protection scope of the present disclosure.

In the description of implementations of the present disclosure, the term “include” and similar terms should be understood as open-ended inclusion, that is, “including but not limited to”. The term “based on” should be understood to be “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It can be understood that data (including but not limited to the data itself, the acquisition or use of the data) involved in this technical solution should comply with requirements of corresponding laws and regulations and related rules.

It can be understood that, before using the technical solutions disclosed in the implementations of the present disclosure, the user should be notified of the type, the use range, the use scenario, and the like of the personal information involved in the present disclosure and authorized by the user in an appropriate manner according to related laws and regulations.

For example, when an active request of a user is received, prompt information is sent to the user to explicitly prompt the user, and an operation requested to be performed by the user needs to obtain and use personal information of the user. Therefore, the user can autonomously select, according to the prompt information, whether to provide personal information to software or hardware such as an electronic device, an application, a server or a storage medium that performs the operations of the technical solutions of the present disclosure.

As an optional but non-limiting implementation manner, in response to receiving an active request of the user, a manner of sending prompt information to the user, for example, a manner of popping up a window, the pop-up window may present the prompt information in a text manner. In addition, the pop-up window may further carry a selection control for the user to select “agree” or “disagree” to provide personal information to the electronic device.

It may be understood that the foregoing process of notifying and acquiring user authorization is merely illustrative and does not constitute a limitation on the implementations of the present disclosure, and other manners that meet related laws and regulations may also be applied to the implementations of the present disclosure.

As used herein, the term “in response to” refers to a state in which a corresponding event occurs or a condition is satisfied. It will be understood that the timing of execution of subsequent actions performed in response to the event or condition and the time at which the event occurs or the condition holds are not necessarily strongly associated. For example, in some cases, a subsequent action may be performed immediately when an event occurs or a condition holds; while in other cases, a subsequent action may be performed for a period of time after an event occurs or a condition holds.

### Example Environment

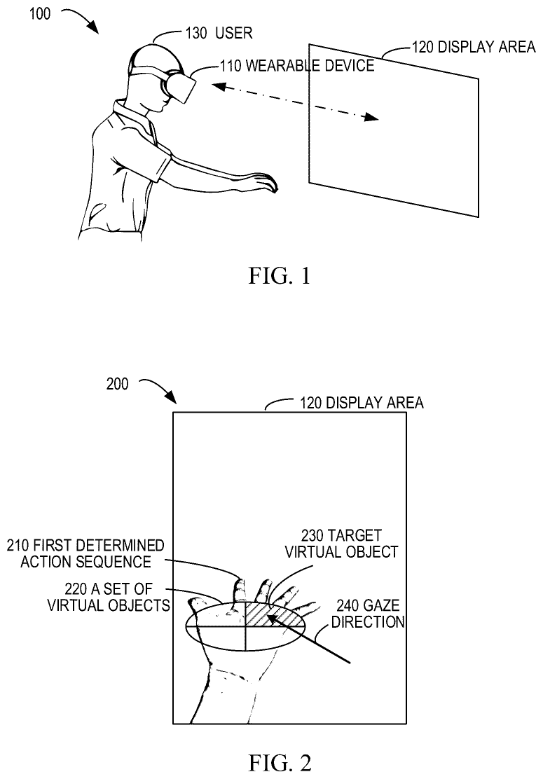

FIG. 1 illustrates a block diagram of an application environment 100 according to an example implementation of the present disclosure. The application environment 100 includes a user 130 and a wearable device 110 thereof. In this application environment 100, the wearable device 110 installs and runs an application that supports a virtual environment, thereby supporting presentation of a display area 120 of the application to the user 130 at or by the wearable device 110.

In some implementations, the display area 120 may provide a virtual environment (e.g., a VR/AR environment). As shown in FIG. 1, after the user 130 wears the wearable device 110, the display area 120 may provide a representation including one or more virtual objects and/or real objects in the real world. The virtual object may include a virtual representation corresponding to a real object in the real world and/or only applicable to an object in the virtual environment. Additionally, the user 130 may input instructions to the application to control the operation of the application.

At present, multiple applications have been developed based on VR/AR, and actions of users of the applications can be detected, thereby controlling various virtual objects in the application based on the detected actions. However, at present, only some simple actions can be identified, and the control method is single and tedious. At this point, it is desirable to provide a more flexible and convenient way to control various virtual objects.

### Controlling Summary of Virtual Objects

To at least partially address deficiencies in the prior art, according to an example implementation of the present disclosure, a method of controlling a virtual object in an application is provided. In summary, actions performed by a user are detected and tracking is performed for multiple types of user interactions. If it is determined that the detected action meets a predetermined condition, a virtual object is presented. Further, if it is determined that the user interaction of the user meets the predetermined condition, the presented virtual object is selected, and then an operation corresponding to the virtual object is performed. In this way, the user does not have to hold a dedicated input device, and user interaction can be provided in a more flexible and efficient manner without interfering with the user's experience of using the application.

It should be understood that the application herein may include multiple types, for example, a dedicated application for implementing some dedicated function, for example, a brush application for editing an image, a text application for editing text, and the like. Alternatively, and/or additionally, the application may further include a system level application, e.g., an operating system, etc.

For ease of description, a detailed process of controlling a virtual object will be described with a brush application as an example of an application. FIG. 2 illustrates a block diagram 200 for controlling a virtual object in an application according to some implementations of the present disclosure. As shown in FIG. 2, the display area 120 may be an interface of the brush application, and a user may interact with the display area 120 to select various brushes and/or colors, and then perform a drawing operation using the selected tool.

As shown in FIG. 2, an action sequence of the user of the application may be detected (for ease of description, the action sequence may be referred to as a first action sequence). It may be determined whether the detected action sequence matches the predetermined action sequence (e.g., the predetermined action sequence for presenting a menu of virtual objects may be referred to as a first predetermined action sequence 210). Here, the first predetermined action sequence 210 may be a default action sequence in the application, or a user-defined action sequence. For ease of description, the first predetermined action sequence 210 herein may be an action sequence of the user's hand, and includes: [placing the hand horizontally, the palm facing upwards, spreading out the palm).

It should be understood that multiple actions in the action sequence herein may respectively correspond to multiple time points, and there is a temporal sequence relationship between the multiple time points. For example, placing the hand horizontally may correspond to time point t1, the palm facing upwards may correspond to time point t2, and spreading out the palm may correspond to time point t3. At this point, t1 precedes t2 and t2 precedes t3.

It should be understood that although the action sequence above includes multiple gestures, alternatively and/or additionally, the action sequence may include only one gesture. In the context of the present disclosure, the predetermined action sequence may include one or more gestures, where the gesture may represent a gesture of the hand of the user, for example, placing the hand horizontally, the palm facing upwards, spreading out the palm, and the like described above.

Alternatively, and/or additionally, the gesture may include the position of the hand, i.e., the position of the hand alone may be utilized to describe the action. For example, different actions may be represented when the user's hand is located at different positions. At this point, the user may move the hand along the spatial trajectory, thereby forming an action sequence. Alternatively, and/or additionally, the action may further involve a gesture and a location of the hand, i.e., describing the gesture with both the gesture and the location of the hand. For example, one action may be represented when the user's palm faces upwards and the hand is in front of the chest; another action may be represented when the user's palms face upwards and the hands are on the side of the body. In this way, the action and position of the hand may be utilized to describe the action in a more accurate manner.

It should be understood that although the action sequence is described above with hand actions as specific examples, alternatively and/or additionally, at least one action of the action sequence may include a body action performed by at least one body part of the user. For example, a body action may be performed by the user's fingers, hands, upper arms, head, leg, torso, and/or other body part(s), or a combination thereof. Here, the body action of the user may be detected separately, for example, the gesture of the body part may be used separately, the position of the body part may be used separately to represent the action, or a combination of the gesture and the position of the body part may be used to represent the action. In this way, actions of multiple body parts of the user may be collected comprehensively.

According to one example implementation of the present disclosure, the action may include an interaction action of the user with an accessory device of the wearable device. For example, the user may operate buttons, scroll wheels, etc. in an accessory device such as a handle to trigger an interaction action. In one example, the user's interaction actions may be detected separately. During operation of the handle by the user, the user can move the position of the handle or keep the position of the handle unchanged, and at this point, only the interaction action between the user and the button, the scroll wheel and the like can be detected, and the change of the position of the hand of the user is ignored. In another example, both the interaction action and the body action of the user may be detected. For example, the user may hold a handle and move the handle along a certain trajectory, and press a button when the handle reaches a predetermined position. At this point, the action sequence may include a combination of the body actions and interaction actions. In this way, richer action sequences may be defined, thereby avoiding a case in which a simple action sequence may be misjudged.

If it is determined that the detected first action sequence of the user matches the first predetermined action sequence 210, a menu may be presented in the display area 120 of the application, that is, the set of virtual objects 220 may be presented in the first format. As shown in FIG. 2, in the brush application scenario, a set of virtual objects 220 may be presented in a circular menu with black, and at this point, the set of virtual objects 220 may include multiple different types of brushes, for example, a pencil, a pen, an oil brush, and the like. Alternatively, and/or additionally, the set of virtual objects 220 may relate to brushes of different colors, e.g., red, yellow, blue, etc. It should be understood that although the set of virtual objects shown above includes multiple virtual objects, alternatively and/or additionally, the set of virtual objects may include only one virtual object. In other words, the set of virtual objects may include at least one virtual object.

Further, it may be determined whether the user interaction of the user matches a certain virtual object in the set of virtual objects. It should be understood that the user interaction herein may be implemented in a plurality of manners, for example, the user interaction may include a user interaction based on at least one of: a gaze direction of the user, an eye action of the user, a sound interaction of the user, or a limb interaction of the user. For ease of description, only the user gaze direction will be used as an example of user interaction in the following. Alternatively, and/or additionally, the user may implement the user interaction with a blinking action, speaking “select” or “flip page”, performing a selection action with the other hand, etc.

According to an example implementation of the present disclosure, if the user interaction is represented with the gaze direction, it may be determined whether the user is gazing at a virtual object in the menu, and then the virtual object is determined and an operation corresponding to the virtual object is performed. If the gaze direction 240 is determined to match a target virtual object 230 in the set of virtual objects 220, and the target virtual object 230 corresponds to a red brush, a drawing operation may be performed with the red brush.

Alternatively, and/or additionally, to facilitate user operation, the target virtual object 230 may be highlighted in the display area 120. For example, the target virtual object 230 may be presented with a second format different from the first format (e.g., in other colors, with framing, changing a display size, changing a display position, or adding other display effects, etc.).

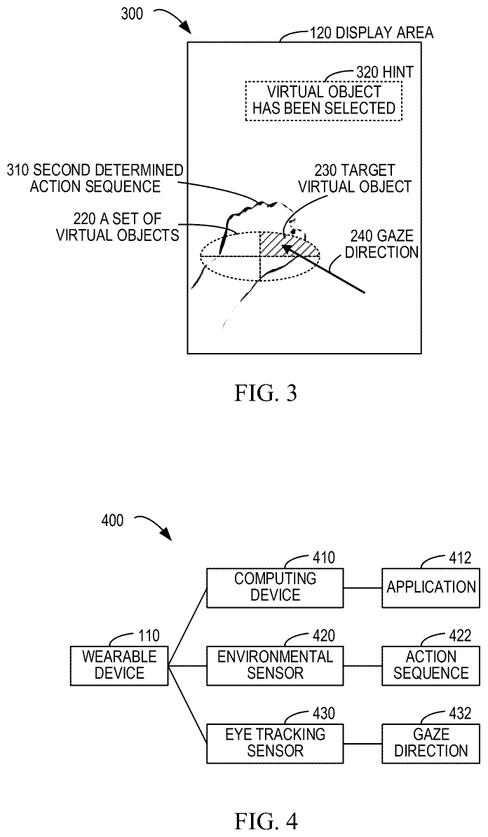

More details are described with reference to FIG. 3, which shows a block diagram 300 for selecting a virtual object according to some implementations of the present disclosure. As shown in FIG. 3, another action sequence (for example, referred to as a second action sequence for short) of the user after the first action sequence may be further detected. Then, it may be determined whether the second action sequence of the user matches another action sequence (e.g., the predetermined action sequence for selecting the virtual object may be referred to as a second predetermined action sequence). In the context of the present disclosure, the second predetermined action sequence may be an action sequence of the user's hand, and includes: [placing the hand horizontally, the palm facing downwards, clenching the fist]. If it is determined that the second action sequence matches the second predetermined action sequence 310, the target virtual object 230 may be selected. As shown by the dashed line in FIG. 3, the set of virtual objects 220 in the circular menu and the target virtual object 230 that has been selected may no longer be presented.

According to an example implementation of the present disclosure, an ending action in the first predetermined action sequence may be the same as a starting action in the second predetermined action sequence. At this point, the second predetermined action sequence may include: [spreading out the palm, the palm facing downwards, clenching the fist]. At this point, no other action is included between the first predetermined action sequence and the second predetermined action sequence. In this way, the action of the user may be detected in a more continuous manner, thereby avoiding an abnormal state in which some irrelevant actions of the user cause an accidental exit from the virtual object.

In this way, user interaction may be provided in a more flexible and efficient manner without interfering with the user's experience of using the application. At this point, the user does not need to hold any input device but may implement user interaction only based on tracking a limb action and an eye action of the user. At this point, the eye action and the limb action of the user may cooperate with each other, that is, the fist is clenched when the eye of the user gazes at the target virtual object, thereby reducing the risk of mistakenly recognizing the intention of the user.

### Detailed Process for Controlling Virtual Objects

Having described a summary of one example implementation according to the present disclosure, more details of controlling a virtual object will be described below. According to an example implementation of the present disclosure, if the user has selected the target virtual object, the selected target virtual object may be presented in the display area with a third format different from the first format and the second format. As shown in FIG. 3, a hint 320 may be provided in the display area 120 to inform the user that a virtual object has been currently selected. Alternatively, and/or additionally, the selected virtual object may be presented at a location near the user's hand, e.g., the selected brush may be presented at the user's finger location, etc. In this way, the user may be notified of the currently selected virtual object, thereby reminding the user that the virtual object may be used to perform a subsequent action.

According to an example implementation of the present disclosure, the above process may be completed by the wearable device 110. FIG. 4 illustrates a block diagram 400 of a structure of a wearable device according to some implementations of the present disclosure. As shown in FIG. 4, the wearable device 110 may include a computing device 410, an environmental sensor 420, and an eye tracking sensor 430.

Herein, the computing device 410 may include various computing devices capable of providing computing capability and may run an application 412 in the computing device, and then provide a display interface of the application in the display area 120. The environmental sensor 420 in the computing device 410 may be deployed outside the wearable device 110 and collect environmental data around the user. For example, image data and/or other data in a range of 360 degrees around the user may be collected to identify an action sequence 422 performed by the user. The eye tracking sensor 430 in the computing device 410 may be deployed in a direction toward the user's eyes in order to collect data to detect and track the user's gaze direction 432 and/or other data with the collected data.

According to an example implementation of the present disclosure, the process described above may be performed in a single wearable device 110. In this way, the user may wear the wearable device 110 and move at will, thereby providing a richer user experience. For example, the brush application herein may be an application that supports a user drawing in the three-dimensional space. At this point, the user may walk to a position where drawing is desired in the physical space and complete the drawing operation. For example, a user may walk to a wall location in a room and draw a mountain painting on the wall. As another example, a user may walk to another wall location in the room and draw a portrait on the wall.

Alternatively, and/or additionally, the computing device 410, environmental sensor 420, and eye tracking sensor 430 may be located at different locations. As long as it can communicate with the computing device 410, environmental sensor 420, and eye tracking sensor 430 via a network. It should be understood that although FIG. 4 only schematically illustrates a wearable device, alternatively and/or additionally, the wearable device may have associated other accessory devices. For example, a handle and/or other accessory device may be utilized to cooperate with the wearable device to achieve more functionality.

According to an example implementation of the present disclosure, the first action sequence performed by the user may be presented in the display area 120. Each action sequence may be presented in a plurality of manners, for example, the action sequence of the user may be displayed based on a perspective function of the headset, or an image of a virtual object capable of representing the action sequence may be simulated with related data of the action sequence, thereby presenting the first action sequence, and the like. Further, a set of virtual objects may be presented near the first action sequence of the user. Returning to FIG. 2, a set of virtual objects 220 may be presented over the user's palm. Herein, the set of virtual objects 220 may be presented in a semitransparent and/or untransparent manner.

At this point, the circular menu representing the plurality of brushes may move accordingly as the user's hand moves. In other words, the presentation position of the set of virtual objects 220 in the display area 120 corresponds to the presentation position of the first action sequence in the display area 120. For example, if the user's hand moves to the right, the circular menu will move to the right with the user's hand. If the user's hand moves to the left, the circular menu will move to the left with the user's hand. The relative positions of the two remain unchanged. In this way, there may be more interactions between the virtual object in the application and the user action, thereby providing a more realistic visual effect.

According to an example implementation of the present disclosure, in the process of determining whether the gaze direction matches the target virtual object, a reference gaze direction of the user may be determined based on the eye position of the user and the virtual object position of the target virtual object. During application running, multiple coordinate systems may be involved. For example, a world coordinate system may be used to describe a physical world in which the user is located, a virtual coordinate system may be used to describe a three-dimensional virtual world corresponding to the physical world, and a screen coordinate system may be used to describe a two-dimensional display area 120 corresponding to the three-dimensional virtual world (that is, the three-dimensional virtual world is projected to the two-dimensional display area 120).

According to an example implementation of the present disclosure, the eye position of the user and the virtual object position of the target virtual object may be determined based on a plurality of mapping relationships (for example, using a transformation matrix) currently known and/or to be developed in the future, thereby determining the reference gaze direction. The reference gaze direction herein may represent a gaze direction that should be followed when the user gazes at the target virtual object. Further, the gaze direction of the user collected by the eye tracking sensor may be compared with the reference gaze direction. If it is determined that the gaze direction matches the reference gaze direction, it may be determined that the gaze direction matches the target virtual object, that is, the user is gazing at the target virtual object.

According to an example implementation of the present disclosure, in a process in which a user selects a virtual object, the user may change a gaze direction and gaze at another virtual object. For example, in FIG. 2, the user may gaze at another virtual object below the target virtual object 230. At this point, the other virtual object will be displayed in the second format, and the target virtual object 230 will restore the first format. In this way, the user may be allowed to flexibly select the virtual object of interest through the gaze direction. This allows the use of eye actions to conveniently switch virtual objects that are desired to be selected without having to use hands and/or other body actions, thereby improving interaction efficiency.

The user may constantly adjust the viewpoint to perform an action to select the desired target virtual object. If the user has selected the target virtual object, a subsequent action sequence may be further detected (for example, the subsequent action sequence after the second action sequence may be referred to as a third action sequence). The environmental sensor 420 described above may be used to collect data, to determine the third action sequence with the collected data, and to perform an operation corresponding to the target virtual object based on the third action sequence.

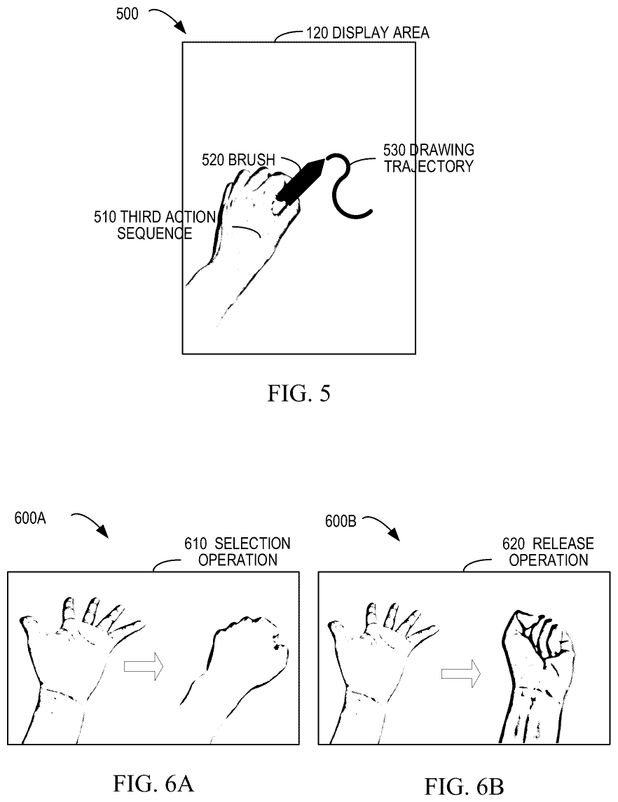

More details are described with reference to FIG. 5, which shows a block diagram 500 of performing an operation with a selected virtual object according to some implementations of the present disclosure. As shown in FIG. 5, assuming that the target virtual object selected by the user is a brush 520, an image of holding the brush 520 by the user's hand may be presented in the display area 120. The user's hand may perform a third action sequence 510 (e.g., drawing a curve) in the real world. At this point, a drawing trajectory 530 will be presented in the display area 120, and the drawing trajectory 530 is drawn with the brush 520 selected by the user. With example implementations of the present disclosure, a user can conveniently implement a corresponding function with a selected virtual object. In this way, a richer interaction experience may be provided.

It should be understood that although the process of controlling a virtual object is described above by way of example as a brush application, alternatively and/or additionally, an application may perform other functions. According to one example implementation of the present disclosure, the set of virtual objects may be a set of controls in the application. In different applications, virtual objects may have different functions. For example, in a game program, the set of virtual objects may be different props in a game, for example, stones, arches, and the like. For another example, in a virtual assembly procedure, the set of virtual objects may be various maintenance tools, such as wrenches and hammers. In this way, it may be convenient to select a desired virtual object to be used with a manner more conforming to the operation habit of the user in the real world, thereby improving interaction efficiency with the application.

Alternatively, and/or additionally, the virtual object may be presented in other graphical representations in the application. For example, a virtual object may include presenting various virtual characters, virtual animals, and/or other virtual items in the application. With example implementations of the present disclosure, multiple virtual objects may be operated in a more flexible manner with the action sequence, thereby providing a more flexible operation manner.

According to an example implementation of the present disclosure, different visual effects may be presented in the display area 120 based on functions of the virtual object. For example, in a gaming application, a user may pick up a stone and make a throwing action. At this point, the environmental sensor 420 may collect data, and further determine a user action (for example, a projection angle, a projection speed, and the like) with the collected data, to generate and present a corresponding throwing trajectory of the stone. After the user has thrown the stone, the next stone may be automatically picked up, at which point the user may perform the throwing action again. For another example, after the user has thrown the stone, the user needs to open the menu again to repick up the stone. For another example, an action sequence of predetermined hands and/or eyes for picking up the next stone may be predefined, or the like. In a virtual assembly application, the user may perform a corresponding operation with a selected tool, for example, rotating a screw with a wrench, or the like.

According to one example implementation of the present disclosure, the user may be allowed to customize predetermined action sequences for performing various operations. FIG. 6A illustrates a block diagram 600A of a predetermined action sequence for a selection operation according to some implementations of the present disclosure. As shown in FIG. 6A, the predetermined action sequence may be customized for performing the selection operation 610: [placing the hand horizontally, the palm facing downwards, clenching the fist]. At this point, after detecting that the user performs the action sequence above, the target virtual object currently being gazing at may be selected.

According to one example implementation of the present disclosure, the user is allowed to release the selected target object. For example, if the user has selected the target virtual object, the user may wish to select another virtual object, or the user has completed use and wishes to replace another virtual object. At this point, a subsequent action sequence performed by the user may be detected (for example, the subsequent action sequence may be referred to as a fourth action sequence). It should be understood that the fourth action sequence may directly follow the second action sequence, which corresponds to a case in which the user wishes to replace the virtual object when the target virtual object is not used. For another example, the fourth action sequence may follow the third action sequence, corresponding to a case in which the user wishes to replace the virtual object after the target virtual object has been used.

According to an example implementation of the present disclosure, it may be determined whether the fourth action sequence of the user matches a predefined action sequence for releasing the virtual object (e.g., referred to as a third predetermined action sequence). If it is determined that the fourth action sequence of the user matches the third predetermined action sequence, the operation corresponding to the target virtual object may be exited. More details are described with reference to FIG. 6B, which illustrates a block diagram 600B of a predetermined action sequence for a release operation according to some implementations of the present disclosure. As shown in FIG. 6B, a predetermined action sequence for performing a release operation 620 may be customized: [placing the hand horizontally, the palm facing upwards, clenching the fist]. At this point, after detecting that the user performs the action sequence above, the operation corresponding to the target virtual object may be exited, that is, the operation drawn with the brush is exited. With example implementations of the present disclosure, user interaction may be performed in a more flexible and efficient manner, thereby providing a richer user experience.

According to an example implementation of the present disclosure, although the case where the third predetermined action sequence is different from the first predetermined action sequence is described above, alternatively and/or additionally, the third predetermined action sequence may be the same as the first predetermined action sequence. That is, the third predetermined action sequence may include the first predetermined action sequence. In this way, the action sequence used to trigger presentation of a set of virtual objects is the same as the action sequence used to exit the operation corresponding to the virtual object, and in this way, user memory can be facilitated.

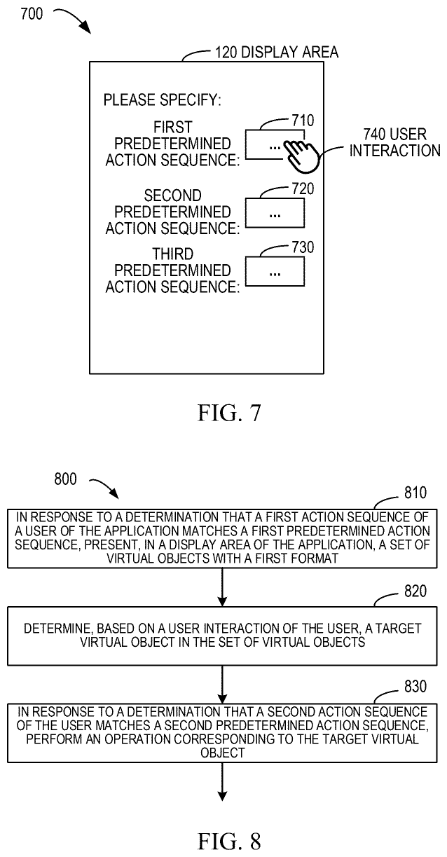

According to an example implementation of the present disclosure, each predetermined action sequence described above (for example, any of the first predetermined action sequence, the second predetermined action sequence and the third predetermined action sequence) may be a default action sequence set by the application. Alternatively, and/or additionally, the predetermined action sequence described above may be specified by the user. More details are described with reference to FIG. 7, which shows a block diagram 700 for specifying a predetermined action sequence according to some implementations of the present disclosure.

As shown in FIG. 7, buttons 710, 720 and 730 for specifying various action sequences may be presented to the user in the display area 120. Specifically, a user interaction 740 for specifying a predetermined action sequence may be detected. If the user interaction 740 is detected, a video may be received specifying the predetermined action sequence. For example, the user may click on the button 710 to record and/or load a video including a hand action from a local or network to specify an action sequence for opening a menu. Similarly, the user may click the button 720 to provide an action sequence for selecting a target virtual object from the menu, and the user may click the button 730 to provide an action sequence for releasing an already selected target virtual object. Further, the predetermined action sequence may be determined from the video based on a variety of ways currently known and/or to be developed in the future.

With example implementations of the present disclosure, a user is allowed to specify a familiar action sequence, thereby facilitating improving interaction efficiency. As the accuracy of various sensors increases, user actions may be identified in a more accurate manner, thereby allowing the user to define an action sequence that includes fewer actions. For example, the user may specify to open a menu with a “snapping fingers” action, select a target virtual object being gazed with an “OK” action, and cancel the selected target virtual object with a “waving a hand” action, etc. In this way, a more convenient and friendly user experience may be provided.

According to an example implementation of the present disclosure, after the menu of the virtual object is presented, if it is determined that the user does not respond for a long time, the menu may no longer be displayed. Specifically, if no action sequence matching the second predetermined action sequence is detected within a predetermined time period, and the gaze direction of the user does not match any virtual object in the set of virtual objects, the set of virtual objects may be removed from the display area. At this point, the user does not gaze at the menu area, which indicates that the user may not wish to use the menu, and thus the menu may be removed.

If the user desires to re-open the menu, the first predetermined action sequence described above may be re-performed to re-present the menu. If the user does not wish to present the menu, the user does not select any target virtual objects at this point, and the user may perform any subsequent actions. In this way, the menu can be closed in time when the user does not need, thereby preventing an error of selecting a virtual object due to misoperation of the user.

Although a process for controlling a virtual object is described above by taking an action of a user's hand as an example, in the context of the present disclosure, an action sequence performed by one or more human body parts may be detected, thereby controlling a corresponding virtual object. At this point, any of the predetermined action sequences (for example, the first predetermined action sequence, the second predetermined action sequence, and the third predetermined action sequence) includes an action sequence executed by any of the following: an arm, two hands, and a single hand.

For example, an action of a user's hand and/or an arm including the hand may be detected. At this point, each action involves more human body parts, so that a relatively complex predetermined action sequence may be predefined. In this way, a richer interaction manner may be provided, and accuracy of determining user interaction is improved. As another example, actions of both hands of the user may be detected. Specifically, the user may perform an action of selecting a virtual object with the left hand and an action of releasing the virtual object with the right hand. In this way, constraints on user actions may be reduced, and the user may select and/or release virtual objects according to their own habits.

As another example, an action of a single hand of a user may be detected. In this way, other human body parts of the user do not need to participate in interaction, and the experience of using the application by the user can be minimally interfered. For example, another hand of the user may control other virtual objects in the application, etc.

With example implementations of the present disclosure, user interaction may be provided in a more flexible and efficient manner without interfering with the user's experience of using the application. At this point, the user does not need to hold any input device but may implement user interaction only based on tracking a limb action and an eye action of the user. In this way, the limb action and the eye action of the user can cooperate with each other, thereby reducing the risk of mistakenly recognizing the intention of the user.

### Example Process

FIG. 8 illustrates a flowchart of a method 800 of controlling a virtual object in an application according to some implementations of the present disclosure. At block 810, in response to a determination that a first action sequence of a user of the application matches a first predetermined action sequence, present, in a display area of the application, a set of virtual objects with a first format. At block 820, determine, based on a user interaction of the user, a target virtual object in the set of virtual objects. At block 830, in response to a determination that a second action sequence of the user matches a second predetermined action sequence, perform an operation corresponding to the target virtual object.

According to an example implementation of the present disclosure, the method further includes: presenting the first action sequence in the display area, wherein a presentation position of the set of virtual objects in the display area corresponds to a presentation position of the first action sequence in the display area.

According to an example implementation of the present disclosure, the method further includes: presenting, in the display area, the target virtual object with a second format different from the first format.

According to an example implementation of the present disclosure, the method further includes: presenting, in the display area, the target virtual object being selected with a third format different from the first format and the second format.

According to an example implementation of the present disclosure, the method further includes: in response to detecting a third action sequence of the user, performing, based on the third action sequence, the operation corresponding to the target virtual object.

According to an example implementation of the present disclosure, the method further includes: in response to a determination that a fourth action sequence of the user matches a third predetermined action sequence, exiting an operation corresponding to the target virtual object.

According to an example implementation of the present disclosure, the third predetermined action sequence comprises the first predetermined action sequence.

According to an example implementation of the present disclosure, the method further includes at least one of: in response to a determination that the user interaction matches a further target virtual object in the set of virtual objects, presenting, in the display area, the further target virtual object with the second format, or in response to that no action sequence matching the second predetermined action sequence is detected within a predetermined time period and the user interaction matches none of the set of virtual objects, removing the set of virtual objects from the display area.

According to an example implementation of the present disclosure, a predetermined action sequence of the first predetermined action sequence and a predetermined action sequence of the second predetermined action sequence are specified by the user.

According to an example implementation of the present disclosure, the method further includes: in response to a user interaction for specifying the predetermined action sequence being detected, receiving a video for specifying the predetermined action sequence; and determining the predetermined action sequence from the video.

According to an example implementation of the present disclosure, any of the first predetermined action sequence and the second predetermined action sequence comprises an action sequence performed by any of: an arm, two hands, and a single hand, and an ending action in the first predetermined action sequence is the same as a starting action in the second predetermined action sequence.

According to an example implementation of the present disclosure, any of the first action sequence and the second action sequence is determined based on data collected by at least one of: an environmental sensor in a wearable device worn by the user, or an accessory device associated with the wearable device; a gaze direction of the user interaction is determined based on data collected by an eye tracking sensor in the wearable device; and the application runs on a computing device in the wearable device.

According to an example implementation of the present disclosure, the action sequence comprises at least one action, and the action comprises at least one of: an interaction action between the user and the accessory device, or a body action of at least one body part of the user, the body action being represented by at least one of a posture or a position of the at least one body part of the user.

According to an example implementation of the present disclosure, the set of virtual objects is a set of controls in the application, and the user interaction comprises a user interaction based on at least one of: a gaze direction of the user, an eye action of the user, a sound interaction of the user, or a limb interaction of the user.

### Example Apparatus and Device

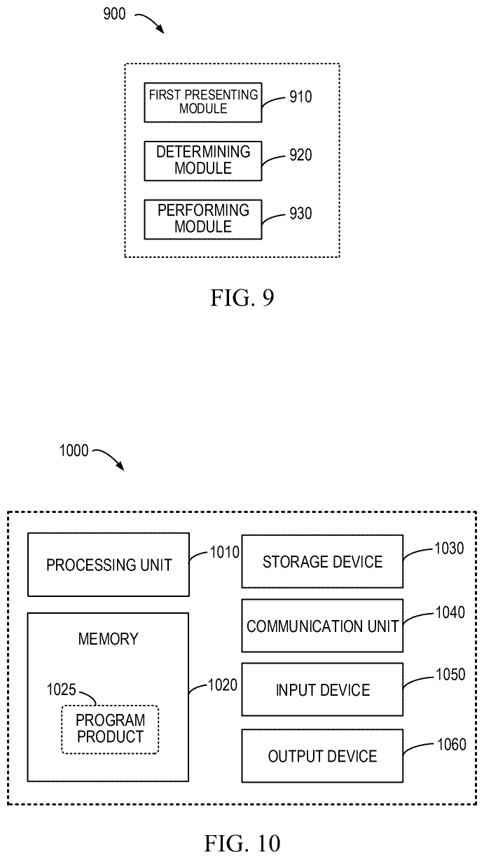

FIG. 9 illustrates a block diagram of an apparatus 900 for controlling a virtual object in an application according to some implementations of the present disclosure. The apparatus 900 includes: a first presenting module 910 configured to, in response to a determination that a first action sequence of a user of the application matches a first predetermined action sequence, present, in a display area of the application, a set of virtual objects with a first format; a determining module 920 configured to determine, based on a user interaction of the user, a target virtual object in the set of virtual objects; and a performing module 930 configured to, in response to a determination that a second action sequence of the user matches a second predetermined action sequence, perform an operation corresponding to the target virtual object.

According to an example implementation of the present disclosure, the apparatus further includes: a second presenting module configured to present the first action sequence in the display area, wherein a presentation position of the set of virtual objects in the display area corresponds to a presentation position of the first action sequence in the display area.

According to an example implementation of the present disclosure, the apparatus further includes: a virtual object presenting module configured to present, in the display area, the target virtual object with a second format different from the first format.

According to an example implementation of the present disclosure, the apparatus further includes: a third presenting module configured to present, in the display area, the target virtual object being selected with a third format different from the first format and the second format.

According to an example implementation of the present disclosure, the apparatus further includes: an operation performing module configured to perform, in response to detecting a third action sequence of the user, based on the third action sequence, the operation corresponding to the target virtual object.

According to an example implementation of the present disclosure, the apparatus further includes: an exiting module configured to, in response to a determination that a fourth action sequence of the user matches a third predetermined action sequence, exit an operation corresponding to the target virtual object.

According to an example implementation of the present disclosure, the third predetermined action sequence comprises the first predetermined action sequence.

According to an example implementation of the present disclosure, the apparatus further includes: a fourth presenting module configured to, in response to a determination that the user interaction matches a further target virtual object in the set of virtual objects, present, in the display area, the further target virtual object with the second format; or a removing module configured to, in response to that no action sequence matching the second predetermined action sequence is detected within a predetermined time period and the user interaction matches none of the set of virtual objects, remove the set of virtual objects from the display area.

According to an example implementation of the present disclosure, a predetermined action sequence of the first predetermined action sequence and a predetermined action sequence of the second predetermined action sequence are specified by the user.

According to an example implementation of the present disclosure, the apparatus further includes: a receiving module configured to, in response to a user interaction for specifying the predetermined action sequence being detected, receiving a video for specifying the predetermined action sequence; and an action sequence determining module configured to determine the predetermined action sequence from the video.

According to an example implementation of the present disclosure, any of the first predetermined action sequence and the second predetermined action sequence comprises an action sequence performed by any of: an arm, two hands, and a single hand, and an ending action in the first predetermined action sequence is the same as a starting action in the second predetermined action sequence.

According to an example implementation of the present disclosure, any of the first action sequence and the second action sequence is determined based on data collected by at least one of: an environmental sensor in a wearable device worn by the user, or an accessory device associated with the wearable device; a gaze direction of the user interaction is determined based on data collected by an eye tracking sensor in the wearable device; and the application runs on a computing device in the wearable device.

According to an example implementation of the present disclosure, the action sequence includes at least one action, and the action includes at least one of: an interaction action between the user and the accessory device, or a body action of at least one body part of the user, the body action being represented by at least one of a posture or a position of the at least one body part of the user.

According to an example implementation of the present disclosure, the set of virtual objects is a set of controls in the application, and the user interaction comprises a user interaction based on at least one of: a gaze direction of the user, an eye action of the user, a sound interaction of the user, or a limb interaction of the user.

FIG. 10 illustrates a block diagram of a device 1000 in which one or more embodiments of the present disclosure may be implemented. It should be understood that the computing device 1000 shown in FIG. 10 is only an example and should not constitute any limitation on the functionality and scope of the embodiments described herein. The computing device 1000 as shown in FIG. 10 may be used to implement the method described above.

As shown in FIG. 10, the computing device 1000 is in the form of a general computing device. The components of computing device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and can execute various processes based on the programs stored in the memory 1020. In a multiprocessor system, multiple processing units execute computer executable instructions in parallel to improve the parallel processing capability of the computing device 1000.

The computing device 1000 typically includes multiple computer storage medium. Such medium may be any available medium that is accessible to the computing device 1000, including but not limited to volatile and non-volatile medium, removable and non-removable medium. The memory 1020 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 1030 may be any removable or non-removable medium, and may include a machine readable medium such as a flash drive, a disk, or any other medium, which may be used to store information and/or data (such as training data for training) and may be accessed within the computing device 1000.

The computing device 1000 may further include additional removable/non-removable, volatile/non-volatile storage medium. Although not shown in FIG. 10, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 1020 may include a computer program product 1025, which has one or more program units configured to perform various methods or acts of various implementations of the present disclosure.

The communication unit 1040 communicates with a further computing device through the communication medium. In addition, functions of components in the computing device 1000 may be implemented by a single computing cluster or multiple computing machines, which can communicate through a communication connection. Therefore, the computing device 1000 may be operated in a networking environment using a logical connection with one or more other servers, a network personal computer (PC), or another network node.

The input device 1050 may be one or more input devices, such as a mouse, a keyboard, a trackball, etc. The output device 1060 may be one or more output devices, such as a display, a speaker, a printer, etc. The computing device 1000 may also communicate with one or more external devices (not shown) through the communication unit 1040 as required. The external device, such as a storage device, a display device, etc., communicate with one or more devices that enable users to interact with the computing device 1000, or communicate with any device (for example, a network card, a modem, etc.) that makes the computing device 1000 communicate with one or more other electronic devices. Such communication may be executed via an input/output (I/O) interface (not shown).

According to example implementation of the present disclosure, a computer readable storage medium is provided, on which computer executable instructions are stored, wherein the computer executable instructions is executed by the processor to implement the method described above. According to example implementation of the present disclosure, a computer program product is also provided. The computer program product is physically stored on a non-transient computer-readable medium and includes computer-executable instructions, which are executed by the processor to implement the method described above. According to example implementation of the present disclosure, a computer program product is provided, on which a computer program is stored, wherein the computer program, when executed by a processor, implements the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various embodiments disclosed herein.

What is claimed is:

1. A method of controlling a virtual object in an application, comprising:
in response to a determination that a first action sequence of a user of the application matches a first predetermined action sequence, presenting, in a display area of the application, a set of virtual objects with a first format;
determining, based on a user interaction of the user, a target virtual object in the set of virtual objects; and
in response to a determination that a second action sequence of the user matches a second predetermined action sequence, performing an operation corresponding to the target virtual object.

2. The method of claim 1, further comprising:
presenting the first action sequence in the display area, wherein a presentation position of the set of virtual objects in the display area corresponds to a presentation position of the first action sequence in the display area.

3. The method of claim 1, further comprising:
presenting, in the display area, the target virtual object with a second format different from the first format.

4. The method of claim 3, further comprising:
presenting, in the display area, the target virtual object being selected with a third format different from the first format and the second format.

5. The method of claim 1, further comprising:
in response to detecting a third action sequence of the user, performing, based on the third action sequence, the operation corresponding to the target virtual object.

6. The method of claim 1, further comprising:
in response to a determination that a fourth action sequence of the user matches a third predetermined action sequence, exiting an operation corresponding to the target virtual object.

7. The method of claim 6, wherein the third predetermined action sequence comprises the first predetermined action sequence.

8. The method of claim 3, further comprising at least one of:
in response to a determination that the user interaction matches a further target virtual object in the set of virtual objects, presenting, in the display area, the further target virtual object with the second format, or
in response to that no action sequence matching the second predetermined action sequence is detected within a predetermined time period and the user interaction matches none of the set of virtual objects, removing the set of virtual objects from the display area.

9. The method of claim 1, wherein a predetermined action sequence of the first predetermined action sequence and a predetermined action sequence of the second predetermined action sequence are specified by the user.

10. The method of claim 9, further comprising:
in response to a user interaction for specifying the predetermined action sequence being detected, receiving a video for specifying the predetermined action sequence; and
determining the predetermined action sequence from the video.

11. The method of claim 1, wherein any of the first predetermined action sequence and the second predetermined action sequence comprises an action sequence performed by any of: an arm, two hands, and a single hand, and an ending action in the first predetermined action sequence is the same as a starting action in the second predetermined action sequence.

12. The method of claim 1, wherein:
any of the first action sequence and the second action sequence is determined based on data collected by at least one of: an environmental sensor in a wearable device worn by the user, or an accessory device associated with the wearable device;
a gaze direction of the user interaction is determined based on data collected by an eye tracking sensor in the wearable device; and
the application runs on a computing device in the wearable device.

13. The method of claim 12, wherein the action sequence comprises at least one action, and the action comprises at least one of:
an interaction action between the user and the accessory device, or
a body action of at least one body part of the user, the body action being represented by at least one of a posture or a position of the at least one body part of the user.

14. The method of claim 1, wherein the user interaction comprises a user interaction based on at least one of: a gaze direction of the user, an eye action of the user, a sound interaction of the user, or a limb interaction of the user.

15. An electronic device comprising:
at least one processing unit; and
at least one memory coupled to the at least one processing unit and storing instructions for execution by the at least one processing unit, the instructions, when executed by the at least one processing unit, causing the electronic device to perform acts for controlling a virtual object in an application, the acts comprising:
in response to a determination that a first action sequence of a user of the application matches a first predetermined action sequence, presenting, in a display area of the application, a set of virtual objects with a first format;
determining, based on a user interaction of the user, a target virtual object in the set of virtual objects; and
in response to a determination that a second action sequence of the user matches a second predetermined action sequence, performing an operation corresponding to the target virtual object.

16. The device of claim 15, wherein the acts further comprise:
presenting the first action sequence in the display area, wherein a presentation position of the set of virtual objects in the display area corresponds to a presentation position of the first action sequence in the display area.

17. The device of claim 15, wherein the acts further comprise:
presenting, in the display area, the target virtual object with a second format different from the first format.

18. The device of claim 15, wherein the acts further comprise:
in response to detecting a third action sequence of the user, performing, based on the third action sequence, the operation corresponding to the target virtual object.

19. The device of claim 15, wherein the acts further comprise:
in response to a determination that a fourth action sequence of the user matches a third predetermined action sequence, exiting an operation corresponding to the target virtual object.

20. A non-transitory computer readable storage medium having a computer program stored thereon, the computer program, when executed by a processor, causing the processor to implement acts for controlling a virtual object in an application, the acts comprising:
in response to a determination that a first action sequence of a user of the application matches a first predetermined action sequence, presenting, in a display area of the application, a set of virtual objects with a first format;
determining, based on a user interaction of the user, a target virtual object in the set of virtual objects; and
in response to a determination that a second action sequence of the user matches a second predetermined action sequence, performing an operation corresponding to the target virtual object.
